(19) United States
(12) Patent Application Publication
(10) Pub. No.: US 2017/0226956 A1
(43) Pub. Date: Aug. 10, 2017

(54) CONTROL APPARATUS FOR INTERNAL COMBUSTION ENGINE

(71) Applicant: TOYOTA JIDOSHA KABUSHIKI KAISHA, Toyota-shi (JP)

(72) Inventors: Yusuke SUZUKI, Hadano-shi (JP); Akio FURUISHI, Gotenba-shi (JP)

(73) Assignee: TOYOTA JIDOSHA KABUSHIKI KAISHA, Toyota-shi (JP)

(21) Appl. No.: 15/425,325

(22) Filed: Feb. 6, 2017

(30) Foreign Application Priority Data
Feb. 8, 2016 (JP) 2016-021968

(51) Int. Cl. F02D 43/04; F02D 41/30; F02P 5/152; F02D 35/02

(52) U.S. Cl. CPC F02D 43/04; F02D 35/023; F02D 35/027; F02D 41/30; F02P 5/152

(57) ABSTRACT

A control apparatus for an internal combustion engine is provided to calculate, on the basis of the output values of the in-cylinder pressure sensor, a combustion index value which indicates the stability of combustion. If reduction of knock is required, the spark timing is retarded. An increment of injected fuel is executed in such a manner that a combustion index value that indicates the actual stability of combustion at a retard execution cycle that is a combustion cycle at which the retard of the spark timing is executed approaches a target value of a combustion index value that indicates the stability of combustion at a before-retard cycle.

### CROSS-REFERENCE TO RELATED APPLICATION

This application is based on and claims the benefit of Japanese Patent Application No. 2016-021968, filed on Feb. 8, 2016, which is incorporated by reference herein in its entirety.

### BACKGROUND

Technical Field

The present disclosure relates to a control apparatus for an internal combustion engine.

Background Art

For example, JP 4-187851A discloses a spark ignition internal combustion engine that includes a fuel injection valve for directly injecting fuel into a cylinder. In this internal combustion engine, if knock occurs, the spark timing is retarded and the amount of fuel injected at the compression stroke is increased.

In addition to JP 4-187851A, JP 2011-174409A is a patent document which may be related to the present disclosure.

### SUMMARY

Where the retard of the spark timing for reducing knock is executed in association with a fuel increment for enriching the air-fuel ratio, it is required to appropriately determine the value of the fuel increment. This is because, if the value of the fuel increment is too large, a knock may be adversely induced due to an increase in the burning velocity, and because if the value of the fuel increment is too small, a torque fluctuation limit may be easy to be reached.

The present disclosure has been made to address the problem described above, and an object of the present disclosure is to provide a control apparatus for an internal combustion engine that is configured, when retarding the spark timing for reducing knock, to be able to accompany a fuel increment for enriching the air-fuel ratio in such a manner as to be able to appropriately control the value of the fuel increment in terms of reducing knock and an increase of torque fluctuation.

A control apparatus for controlling an internal combustion engine according to the present disclosure is configured to control an internal combustion engine that includes: an ignition device configured to ignite air-fuel mixture in a cylinder; a fuel injection valve configured to supply fuel in the cylinder; and an in-cylinder pressure sensor configured to detect an in-cylinder pressure. The control apparatus a controller. The controller is programmed to: detect a knock; calculate, based on an output value of the in-cylinder pressure sensor, an actual combustion index value of a combustion index value that indicates a stability of combustion; control a fuel injection amount in such a manner that the actual combustion index value approaches a target combustion index value that is based on an engine operating condition; retard a spark timing in reducing knock based on a knock detection result; and execute a fuel increment in such a manner that the actual combustion index value at a retard execution cycle that is a combustion cycle at which a retard of the spark timing for reducing knock is executed approaches the target combustion index value of a before-retard cycle that is one or a plurality combustion cycles immediately before the retard execution cycle.

The target combustion index value may be corrected based on a change amount of a value of engine load factor at the retard execution cycle with respect to a value of the engine load factor at the before-retard cycle.

The target combustion index value may be corrected based on a change amount of a value of an engine speed at the retard execution cycle with respect to a value of the engine speed at the before-retard cycle.

According to the control apparatus for an internal combustion engine of the present disclosure, if the spark timing is retarded for reducing knock, an increment of injected fuel is executed in such a manner that the actual combustion index value at the retard execution cycle approaches the target combustion index value at the before-retard cycle. Therefore, the difference between the actual combustion index values at the combustion cycles before and after the execution of the retard of the spark timing can be decreased. With the retard of the spark timing in association with the enrichment of the air-fuel ratio by this kind of fuel increment, the spark timing can be retarded while the torque fluctuation limit can be caused to be harder to be reached as compared with an example of executing only the retard of the spark timing. In addition, an injected fuel is incremented in such a manner that a change of the actual combustion index value as a result of execution of the retard of the spark timing is reduced, and an increase of the burning velocity due to an excessive fuel increment can thereby be reduced. Therefore, a knock can be prevented from being adversely induced due to a fuel increment being executed in association with the retard of the spark timing. As described above, according to the control apparatus of the present disclosure, an increment of injected fuel for enriching the air-fuel ratio can be executed in association with the retard of the spark timing in such a manner as to be able to appropriately control the value of the fuel increment in terms of reducing knock and an increase of torque fluctuation.

### BRIEF DESCRIPTION OF THE DRAWINGS

FIG. 1 is a diagram for explaining a system configuration according to a first embodiment of the present disclosure;

FIG. 2 is a view that represents a waveform of mass fraction burned (MFB) and a spark timing (SA);

FIG. 3 is a graph for explaining a setting of a base spark timing;

FIG. 4 is a graph that illustrates a relation between the spark timing and air-fuel ratio in a lean air-fuel ratio range on the leaner side relative to the stoichiometric air-fuel ratio and a torque fluctuation limit value;

FIG. 5 is a graph that illustrates a torque fluctuation limit line, a base spark timing line (target knock level line) and equal SA-CA10 lines with a relation between these lines, and CA50 and air-fuel ratio (air-fuel ratio in the lean air-fuel ratio range) A/F;

FIG. 6 is a flowchart that represents a control routine executed in the first embodiment;

FIG. 7 is a graph that illustrates a relation between the air-fuel ratio and SA-CA10; and

FIG. 8 is a graph for explaining an effect of utilizing SA-CA10 as a combustion index value for determining a fuel increment value F that is associated with the retard of the spark timing.

### DETAILED DESCRIPTION

### First Embodiment

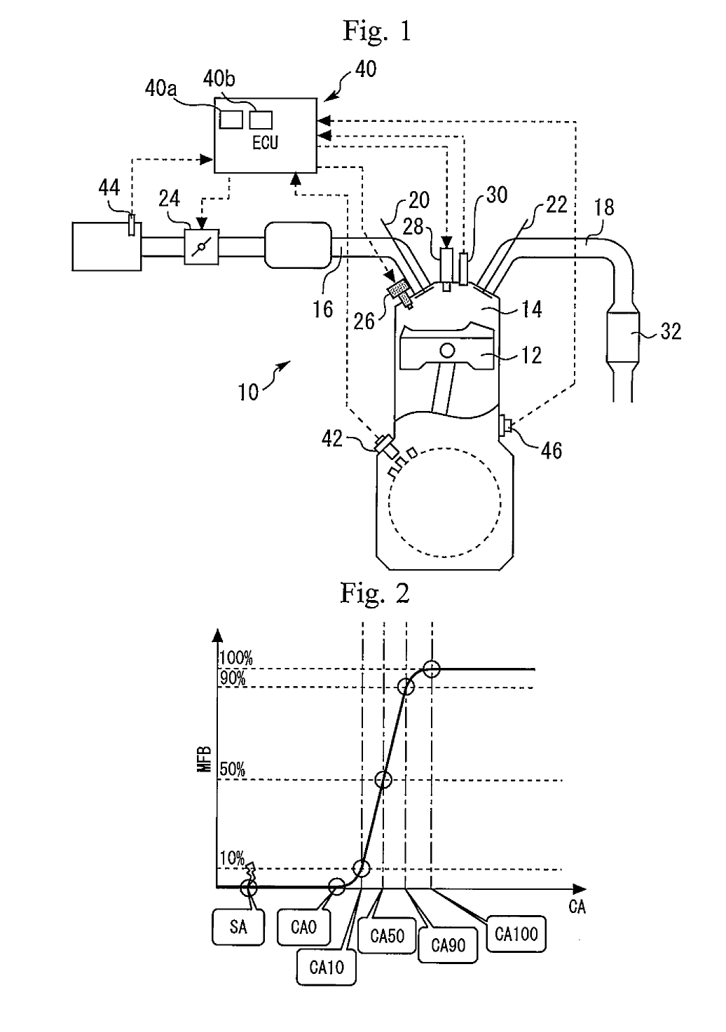

Firstly, a first embodiment of the present disclosure will be described with reference to FIG. 1 to FIG. 8.

### [System Configuration of First Embodiment]

FIG. 1 is a diagram for explaining a system configuration according to a first embodiment of the present disclosure. The system shown in FIG. 1 includes a spark-ignition type internal combustion engine (as an example, gasoline engine) 10. A piston 12 is provided in each cylinder of the internal combustion engine 10. A combustion chamber 14 is formed on the top side of the piston 12 inside the respective cylinders. An intake passage 16 and an exhaust passage 18 communicate with the combustion chamber 14.

An intake valve 20 is provided in an intake port of the intake passage 16. The intake valve 20 opens and closes the intake port. An exhaust valve 22 is provided in an exhaust port of the exhaust passage 18. The exhaust valve 22 opens and closes the exhaust port. An electronically controlled throttle valve 24 is provided in the intake passage 16. Each cylinder of the internal combustion engine 10 is provided with a fuel injection valve 26 for injecting fuel directly into the combustion chamber 14 (into the cylinder), and an ignition device (only a spark plug is illustrated in the drawings) 28 for igniting an air-fuel mixture. An in-cylinder pressure sensor 30 for detecting an in-cylinder pressure is also mounted in each cylinder. Note that a fuel injection valve for supplying fuel into a cylinder of the internal combustion engine 10 may be a port injection type fuel injection valve for injecting fuel into an intake port instead of or in addition to the in-cylinder injection type fuel injection valve 26.

The system of the present embodiment also includes a control apparatus that controls the internal combustion engine 10. The control apparatus includes an electronic control unit (ECU) 40 and drive circuits (not shown in the drawings) for driving various actuators described below. The ECU 40 includes an input/output interface, a memory 40a, and a central processing unit (CPU) 40b. The input/output interface is configured to receive sensor signals from various sensors installed in the internal combustion engine 10 or the vehicle in which the internal combustion engine 10 is mounted, and to also output actuating signals to various actuators which the internal combustion engine 10 includes. Various control programs and maps for controlling the internal combustion engine 10 are stored in the memory 40a. The CPU 40b executes various calculation processing based on a control program from the memory 40a, and generates actuating signals for various actuators based on a received sensor signals.

The sensors from which the ECU 40 receives signals include, in addition to the aforementioned in-cylinder pressure sensor 30, various sensors for acquiring the engine operating state, such as a crank angle sensor 42 that is arranged in the vicinity of a crank shaft (not illustrated in the drawings), an air flow sensor 44 that is arranged in the vicinity of an inlet of the intake passage 16, and a knock sensor 46 for detecting a knock. As an example of the knock sensor 46, a sensor of a type detecting, with a piezoelectric element, the vibration of the internal combustion engine 10 that is transmitted to a cylinder block can be used.

The actuators to which the ECU 40 outputs actuating signals include various actuators for controlling operation of the engine, such as the above described throttle valve 24, fuel injection valve 26 and ignition device 28. The ECU 40 also has a function that synchronizes an output signal of the in-cylinder pressure sensor 30 with a crank angle, and subjects the synchronized signal to AD conversion and acquires the resulting signal. It is thereby possible to detect an in-cylinder pressure at an arbitrary crank angle timing in a range allowed by the AD conversion resolution. In addition, the ECU 40 stores a map in which the relation between a crank angle and an in-cylinder volume is defined, and can refer to the map to calculate an in-cylinder volume that corresponds to a crank angle.

### [Control in First Embodiment]

(Calculation of Measured Data of MFB Utilizing in-Cylinder Pressure Sensor)

FIG. 2 is a view that represents a waveform of mass fraction burned (MFB) and a spark timing (SA). According to the system of the present embodiment that includes the in-cylinder pressure sensor 30 and the crank angle sensor 42, in each cycle of the internal combustion engine 10, measured data of an in-cylinder pressure P can be acquired in synchrony with a crank angle (more specifically, a set of in-cylinder pressures P that are calculated as values for the respective predetermined crank angles). A heat release amount Q inside a cylinder at an arbitrary crank angle θ can be calculated according to the following equations (1) and (2) using the measured data of the in-cylinder pressure P and the first law of thermodynamics. Furthermore, a mass fraction burned (hereunder, referred to as “MFB”) at an arbitrary crank angle θ can be calculated in accordance with the following equation (3) using the measured data of the heat release amount Q inside a cylinder (more specifically, a set of heat release amounts Q calculated as values for the respective predetermined crank angles). On that basis, measured data of MFB (measured MFB set) that is synchronized with the crank angle can be calculated by executing, at each predetermined crank angle, processing to calculate the MFB. The measured data of MFB is calculated in a combustion period and in a predetermined crank angle period before and after the combustion period (here, as one example, the crank angle period is from a closing timing IVC of the intake valve 20 to an opening timing EVO of the exhaust valve 22).

$$\begin{matrix}dQ / d θ = \frac{1}{κ - 1} \times ( V \times \frac{dP}{d θ} + P \times κ \times \frac{dV}{d θ} & ( 1 ) \\ Q = \sum \frac{dQ}{d θ} & ( 2 ) \\ MFB = \frac{Q ( θ ) - Q ( {θ}_{min} )}{Q ( {θ}_{max} ) - Q ( {θ}_{min} )} \times 100 & ( 3 )\end{matrix}$$

Where, in the above equation (1), V represents an in-cylinder volume and κ represents a ratio of specific heat of in-cylinder gas. Further, in the above equation (3), θₘᵢₙ represents a combustion start point and θₘₐₓ represents a combustion end point.

According to the measured data of MFB that is calculated by the above method, a crank angle at which MFB reaches a specified fraction α (%) (hereunder, referred to as “specified fraction combustion point”, and indicated by attaching “CAα”) can be calculated. Next, a typical specified fraction combustion point CAα will now be described with reference to FIG. 2. Combustion in a cylinder starts with an ignition delay after igniting an air-fuel mixture is performed at the spark timing (SA). A start point of the combustion (θₘᵢₙ in the above described equation (3)), that is, a crank angle at which MFB starts to rise is referred to as “CA0”. A crank angle period (CA0-CA10) from CA0 until a crank angle CA10 at which MFB reaches 10% corresponds to an initial combustion period, and a crank angle period (CA10-CA90) from CA10 until a crank angle CA90 at which MFB reaches 90% corresponds to a main combustion period. Further, according to the present embodiment, a crank angle CA50 at which MFB reaches 50% is used as a combustion center. A crank angle CA100 at which MFB reaches 100% corresponds to a combustion end point (θₘₐₓ in the above described equation (3)) at which the heat release amount Q reaches a maximum value. The combustion period is defined as a crank angle period from CA0 to CA100.

### (Base Spark Timing)

A base spark timing is set in advance as a value according to operating conditions of the internal combustion engine 10 (mainly, engine load (engine torque) and engine speed), and stored in the memory 40a. The engine torque can be calculated, for example, using the measured data of the in-cylinder P obtained with the in-cylinder pressure sensor 30.

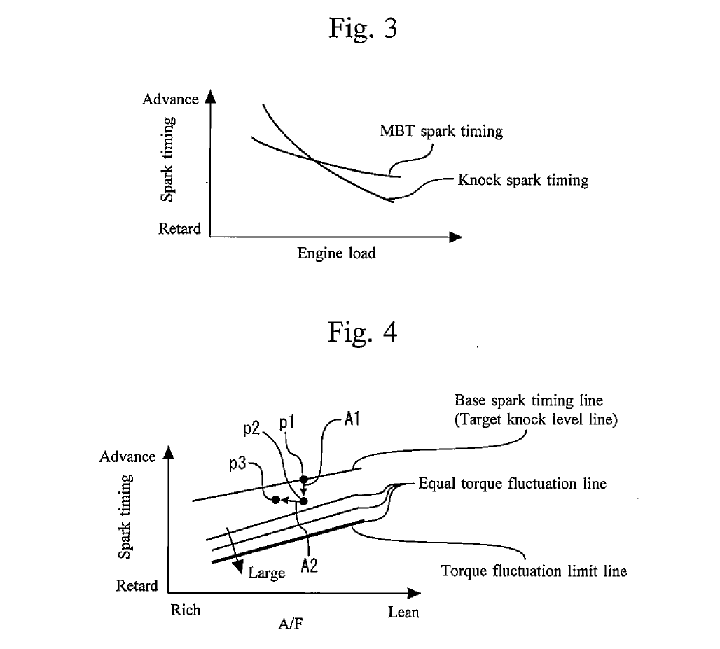

FIG. 3 is a graph for explaining a setting of the base spark timing, and represents, as an example, a relation between the base spark timing at a predetermined engine speed and the engine load. FIG. 3 shows two kind of spark timings that can be used as the base spark timing, that is, an MBT (Minimum Advance for Best Torque) spark timing and a knock spark timing.

The knock spark timing mentioned here is a spark timing at which a predetermined target knock level is obtained. The knock level is an index based on a knock intensity and a knock frequency (more specifically, an index that is defined so as to be higher as the knock intensity is greater and also to be higher so as to be higher as the knock frequency is higher). The knock intensity can be calculated, for example, as a value according to the intensity of vibration calculated based on the output signals of the knock sensor 46. A knock frequency means a frequency with which knocks with a specified knock intensity occur during a predetermined plurality of cycles. Accordingly, the knock level increases as the knock intensity of knocks that occur during a predetermined plurality of cycles increases, and the knock level also increases as the knock frequency during the predetermined plurality of cycles increases.

Since the in-cylinder pressure and in-cylinder temperature at a time of combustion becomes higher as the engine load is higher, a knock becomes likely to occur. As a result, the MBT spark timing moves to the retard side as the engine load is higher. In addition, as the engine load increases, a knock with a greater knock intensity becomes likely to occur and the knock frequency also becomes likely to occur. As a result, the knock spark timing (that is, a spark timing at which a target knock level is obtained as described above) moves to the retard side as the engine load is higher. Further, as shown in FIG. 3, on the low load side, the MBT spark timing is retarded relative to the knock spark timing, and, on high load side, the knock spark timing is retarded relative to the MBT spark timing. As a base spark timing at each engine load, the greater of retard values of these MBT spark timing and knock spark timing is selected.

### (Outline of Knock Control)

The control of spark timing for the internal combustion engine 10 is performed by taking, as a target spark timing, the spark timing obtained by adding a spark timing retard amount (corrected amount) to the base spark timing described above. A retard request that is assumed in the present embodiment is a request for retarding the spark timing to reduce knock (more specifically, to decrease the knock level).

In the present embodiment, a knock control is performed. According to the knock control, the spark timing is controlled so as to cause the knock level to approach the target knock level. The retard request for decreasing the knock level is a request that may be issued during performance of the knock control. The memory 40a stores the base spark timing as a value under a standard condition concerning combustion (more specifically, under a condition in which parameters, such as intake air temperature, engine cooling water temperature and octane number, have standard values). If the internal combustion engine 10 is operated in a condition that is closer to this standard condition, the target knock level can be achieved with the target spark timing that corresponds to the base spark timing. If, on the other hand, the base spark timing is used as it is when the intake air temperature is higher than a standard value because of the internal combustion engine 10 being operated at a high outdoor air temperature area or when a fuel whose octane number is lower is used, there is a possibility that the knock level may be higher than the target knock level. As a result, the retard of the spark timing is required to decrease the knock level to the target knock level.

An example of the knock control is described here in detail. The spark timing retard amount used for this knock control is learned with the following processing and stored in the memory 40a. This spark timing retard amount is increased and decreased in accordance with the knock level (that is, the knock intensity and knock frequency calculated based on the results of knock detection using the knock sensor 46). More specifically, when the knock level is higher than the target knock level (specifically, when the knock intensity is greater than a knock intensity at the target knock level or when the knock frequency is greater than a knock frequency at the target knock level), the spark timing retard amount is corrected so as to be greater by a predetermined amount R1 and stored in the memory 40a. As a result, the target spark timing at a cylinder at which combustion is performed thereafter is retarded with respect to the current value. If the spark timing is retarded, the maximum value Pmax of the in-cylinder pressure can be lowered by decreasing the burning velocity of air-fuel mixture, and thus, the knock intensity and the knock frequency can be lowered. The knock level can therefore be lowered. If, on the other hand, a time period during which it is determined that the knock level is equal to or lower than the target knock level is continuously reached to a predetermined time period, an advance request for the spark timing is issued and the spark timing retard amount is corrected so as to be less by a predetermined amount R2 and stored in the memory 40a. As a result, the target spark timing at a cylinder at which combustion is performed thereafter is advanced with respect to the current value. Note that the minimum value of the spark timing retard amount is zero, and therefore, the limit value of the target spark timing on the advance side is the same as the base spark timing.

According to the knock control described so far, the target knock level can be maintained even when the condition concerning combustion, such as the intake air temperature, shifts to a severe side from the view point of knock as compared with the standard condition.

### (Relation Between Base Spark Timing and Torque Fluctuation Limit at Time of Lean Burn Operation)

In the present embodiment, lean burn operation is performed, as a premise, with a lean air-fuel ratio that is greater than the stoichiometric air-fuel ratio. FIG. 4 is a graph that illustrates a relation between the spark timing and air-fuel ratio in a lean air-fuel ratio range on the leaner side relative to the stoichiometric air-fuel ratio and a torque fluctuation limit value. Note that FIG. 4 shows, as an example, a relation at the same engine load and engine speed in a high load range in which the knock spark timing is selected as the base spark timing. In addition, the line of the base spark timing shown in FIG. 4 corresponds to an equal knock level line on which the knock level is constant with the target knock level.

An operating point p1 shown in FIG. 4 corresponds to an operating point p (that is, an adapted point that is determined in advance) where the base spark timing (in FIG. 4, knock spark timing) is used as the target spark timing. Note that, in a range on the low load side in which the MBT spark timing is used as the base spark timing, a spark timing at the operating point p1 (adapted point) corresponds to the MBT spark timing in contrast to the example shown in FIG. 4.

If the above-described knock control to retard the spark timing by the predetermined amount R1 is sorely performed, the operating point p moves from the operating point P1 to an operating point p2 located just under the operating point p1 in FIG. 4, as shown by an arrow A1 in FIG. 4.

On the other hand, in order to ensure the stability of combustion in retarding the spark timing, there is a method that an increment of fuel injected for enriching the air-fuel ratio is executed in association with the retard of the spark timing. If the increment of fuel is executed after execution of the retard of the spark timing, the movement of the operating point P1 includes not only the movement shown by the arrow A1 but also the movement shown by an arrow A2 due to the increment of fuel. As a result, the operating point P moves to an operating point p3 that is located on the richer side and the retard side relative to the operating point p1. When the spark timing is retarded during the lean burn operation, the torque fluctuation is easy to be greater than when the spark timing is retarded during the stoichiometric air-fuel ratio burn operation. Therefore, the width from the base spark timing to a torque fluctuation limit line at the time of the lean burn operation becomes shorter than that at the time of the stoichiometric air-fuel ratio burn operation (that is, a margin for the retard becomes smaller). More specifically, the margin in the lean air-fuel ratio range becomes smaller as the air-fuel ratio is leaner. Because of this, by executing the increment of injected fuel as well as the retard of the spark timing, the distance (margin) from the operating point p3 to the torque fluctuation limit line after execution of the retard with a same amount (predetermined amount R1) can be increased as compared with when only the retard is executed, as represented in FIG. 4.

### (Determination Method for Increment Value F of Injected Fuel According to First Embodiment in Retarding Spark Timing)

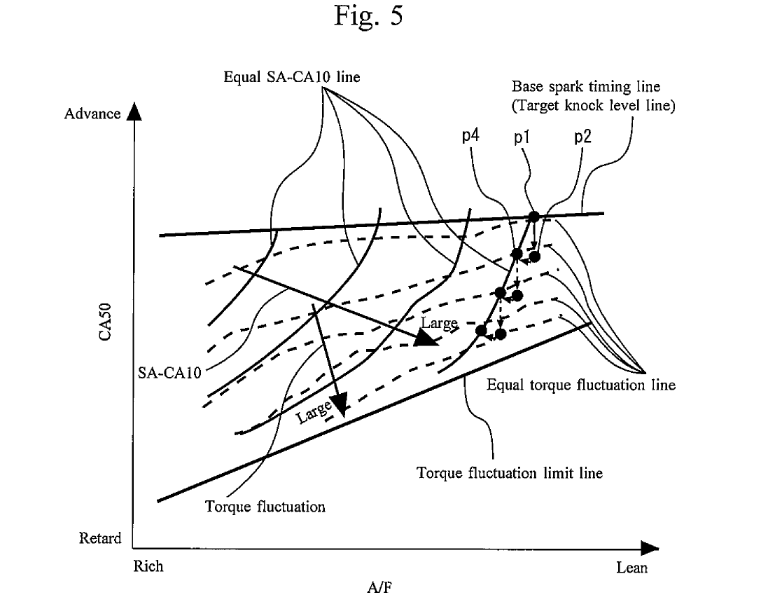

When the retard of the spark timing for reducing knock is executed in association with an increment of injected fuel, there is a possibility that, if the value of the fuel increment is too large, a knock may be adversely induced due to an increase in the burning velocity, and there is a possibility that, if the value of the fuel increment is too small, a torque fluctuation limit may be easy to be reached. Therefore, it is required to appropriately determine the value of the fuel increment. In the present embodiment, the increment value F of injected fuel in retarding the spark timing for reducing knock is determined using a method described below with reference to FIG. 5.

FIG. 5 is a graph that illustrates a torque fluctuation limit line, a base spark timing line (target knock level line) and equal SA-CA10 lines with a relation between these lines, and CA50 and air-fuel ratio (air-fuel ratio in the lean air-fuel ratio range) A/F. SA-CA10 shown in FIG. 5 is a parameter used in the present embodiment as a combustion index value that indicates the stability of combustion. SA-CA10 is a crank angle width from the spark timing to CA10 (more specifically, a difference that is obtained by subtracting the spark timing (SA) from CA10). CA50 (combustion center) that is a vertical axis of FIG. 5 retards when the spark timing is retarded, and advances when the spark timing is advanced.

More specifically, SA-CA10 is proportional to the length of an ignition delay period. The ignition delay period increases as the air-fuel ratio is leaner. Thus, as shown in FIG. 5, the value of SA-CA10 at the same CA50 increases as the air-fuel ratio is leaner. As seen from the above, it can be said that SA-CA10 is a combustion index value which indicates the stability of combustion as described above, and that it is especially an index value which indicates the ignitability of air-fuel mixture. Each equal SA-CA10 line has a tendency that, as shown in FIG. 5, SA-CA10 decreases as CA50 is retarded to a greater extent.

The operating point p1 shown in FIG. 5 is an operating point p when the base spark timing (in FIG. 5, knock spark timing) is used as the target spark timing (that is, p1 is an adapted point that is determined in advance). Note that, in contrast to the example shown in FIG. 5, the spark timing at the operating point p1 (adapted point) in a range on the low load side in which the MBT spark timing is used as the base spark timing corresponds to the MBT spark timing. The base spark timing line on which the operating point p1 lies corresponds to the target knock level line.

In the present embodiment, when the spark timing is retarded for reducing knock (more specifically, for decreasing the knock level), the increment value F of fuel injection is determined in such a manner that an actual SA-CA10 at a combustion cycle at which the retard is executed (hereunder, referred to as a “retard execution cycle”) approaches an SA-CA10 (more specifically, a target SA-CA10 described below) at one or a plurality combustion cycles immediately before the start of the retard (hereafter, referred to as a “before-retard cycle”). Note that the retard execution cycle differs depending on the manner of occurrence of knock and is therefore one or a plurality of combustion cycles.

In the present embodiment, the following manner is used as one of a concrete example of the determination method for the increment value F described above. More specifically, in the present embodiment, the fuel injection amount is controlled, as a premise, in such a manner that the actual SA-CA10 approaches the target SA-CA10 according to the engine operating condition (as an example, engine load factor and engine speed) during the lean burn operation. This control is referred to as “SA-CA10 feedback control” to facilitate description of the present disclosure.

The target SA-CA10 used for the fuel injection amount control described above is utilized for the determination of the increment value F according to the present embodiment. Specifically, in the retard execution cycle, again, the SA-CA10 feedback control described above is performed continuously. As a result, the fuel injection amount is corrected in such a manner that the actual SA-CA10 at the retard execution cycle approaches the target SA-CA10 at the before-retard cycle. As described above, if only the retard of the spark timing is executed, the actual SA-CA10 becomes greater. In contrast to this, enriching the air-fuel ratio can decrease the actual SA-CA10. Therefore, if it is required that the actual SA-CA10 at the retard execution cycle be caused to approach the target SA-CA10 at the before-retard cycle with the SA-CA10 feedback control, the fuel injection amount is corrected so as to be greater. This correction amount corresponds to the increment value F described above. In this way, the increment value F can be determined using the SA-CA10 feedback control.

If the fuel increment with the aforementioned increment value F is performed additionally after the spark timing is retarded from the operation point p1 by the predetermined amount R1, the operating point p moves to an operating point p4 on the equal SA-CA10 line on which the operating point p1 lies, as shown in FIG. 5. During the retard request being present, the retard of the spark timing for reducing knock is repeatedly executed with an increase in the spark timing retard amount by the predetermined amount R1. As a result, the operating point p moves so as to trace the equal SA-CA10 line on which the operating point p1 lies. In this way, utilizing the increment value F can make the actual SA-CA10 nearly uniform before and after the execution of the retard of the spark timing. Note that, if only the retard of the spark timing is executed without being associated with the increment of injected fuel in constant to the method shown in FIG. 5, SA-CA10 becomes greater as compared with before the start of the retard, as seen from the relation shown in FIG. 5.

Here, a supplementary explanation is made for the above-described control to make the actual SA-CA10 nearly uniform before and after the execution of the retard of the spark timing. In the example of the movement of the operating point p shown in FIG. 5, the engine operating condition does not vary before and after the execution of the retard of the spark timing. If the engine operating condition used to determine the target SA-CA10 varies, the target SA-CA10 is changed. Thus, if the engine operating condition has varied before and after the execution of the retard of the spark timing, the target SA-CA10 is changed, before and after the execution of the retard of the spark timing, by an amount corresponding to a change of the engine operating condition. However, it can be said that, even if the target SA-CA10 is changed in this way as a result of a change of the engine operating condition before and after the execution of the retard of the spark timing, the actual SA-CA10 is made nearly uniform before and after the execution of the retard of the spark timing more favorably as compared with when this control is not applied. In addition, even if the target SA-CA10 is changed as described above, combustion before and after the execution of the retard of the spark timing can be controlled in such a manner that an desired degree of stability of combustion is maintained.

Furthermore, in the present embodiment, even if the advance request for the spark timing is issued in the knock control, the fuel injection amount is controlled so as to make SA-CA10s nearly uniform at combustion cycles before and after the execution of the advance of the spark timing, as in when the retard request is issued. More specifically, the fuel injection amount is corrected in such a manner that the actual SA-CA10 at a combustion cycle at which the advance is executed approaches the target SA-CA10 used at a combustion cycle immediately before the start of the advance. However, when the advance of the spark timing is executed, the fuel injection amount is decreased.

### (Concrete Processing According to First Embodiment)

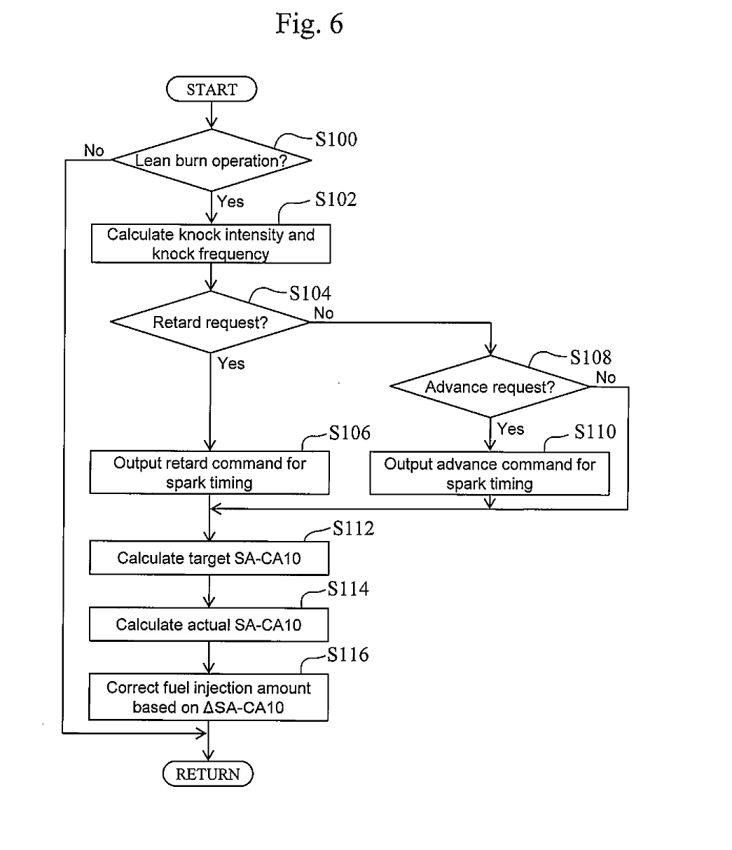

Next, FIG. 6 is a flowchart that represents a control routine executed in the first embodiment. Note that the present routine is started up at a timing that has elapsed the opening timing of the exhaust valve 22 in each cylinder (that is, a timing that has completed the acquisition of the data of the in-cylinder pressure P that is the basis for calculation of the measured data of MFB) and repeatedly executed for each combustion cycle.

In the routine shown in FIG. 6, first, the ECU 40 determines whether or not the lean burn operation is being performed (step S100). In the internal combustion engine 10, the lean burn operation is performed with an air-fuel ratio that is greater (leaner) than the stoichiometric air-fuel ratio in a predetermined operating range. In this step S100, it is determined whether or not the present operating range corresponds to an operating range in which this kind of lean burn operation is performed. The operating range mentioned here can be defined, for example, on the basis of the engine load factor and the engine speed. The engine load factor can be calculated, for example, on the basis of an intake air flow rate that is obtained using the air-flow sensor 44 and the engine speed.

If the ECU 40 determines in step S100 that the lean burn operation is being performed, the ECU 40 calculates the knock intensity and the knock frequency (step S102). Specifically, the knock intensity at the time of combustion at the current combustion cycle is calculated on the basis of the output signals of the knock sensor 46. Further, the knock frequency is calculated as a frequency with which a knock having a knock intensity that is equal to a target knock level determined in advance occurs during a predetermined plurality of cycles (including the current combustion cycle).

Next, the ECU 40 determines whether or not the retard request for the spark timing for decreasing the knock level is present (step S104). The retard request is issued when the current knock level is higher than a target knock level (specifically, when the knock intensity calculated in step S102 is greater than a knock intensity at the target knock level or when the knock frequency calculated in step S102 is higher than a knock frequency at the target knock level).

If the ECU 40 determines in step S104 that the retard request is present, the ECU 40 outputs a retard command for the spark timing to the ignition device 28 (step S106). As a result of this, the spark timings that are used at the combustion cycles in each cylinder that are performed after the present retard request is issued is retarded. As already described, the target spark timing is a value that is obtained by adding a spark timing retard amount to the base spark timing. The base spark timing can be calculated with reference to a map (not shown in the drawings) that defines a relation between the engine operating condition (for example, engine load and engine speed) and the base spark timing. The base spark timing defined in this map is determined taking into consideration the target air-fuel ratio at each engine operating condition.

According to the processing of this step S106, upon the above-described retard request, the predetermined amount R1 to increase the retard amount relative to the current spark timing retard amount is added. With the addition of the predetermined amount R1, first, the spark timing retard amount is corrected from the current value (that is, a value stored in the memory 40a) and stored in the memory 40a. Further, a corrected spark timing retard amount is added to the base spark timing, and thereby, the target spark timing is corrected. Therefore, according to the retard command described above, the target spark timing that is corrected in this way is commanded. Note that the predetermined amount (one retard amount) R1 may be a fixed value, or may be a value, for example, that is variable in accordance with at least one of the knock intensity and the knock frequency.

If, on the other hand, the ECU 40 determines in step S104 that the retard request is not present, next, the ECU 40 determines whether or not the advance request for the spark timing is present (step S108). The advance request can be determined, for example, on the basis of whether or not a time period during which it is determined that the knock level is equal to or lower than the target knock level is continuously reached to a predetermined time period. As a result of this, if the ECU 40 determines that the advance request is present, the ECU 40 outputs an advance command for the spark timing to the ignition device 28 (step S110). As a result of this, the spark timing retard amount that is reflected to the base spark timing is corrected so as to be smaller by a predetermined amount R2. That is, the target spark timing is advanced with respect to the current value. Note that this predetermined amount R2 may be the same as the predetermined amount R1 for the retard of the spark timing, or may be a value different from the predetermined amount R1.

Moreover, in the routine shown in FIG. 6, if the retard command (step S106) is issued, or if the advance command (step S110) is issued, or if the ECU 40 determines that both of the retard command and the advance command are not present, the ECU 40 proceeds to step S112.

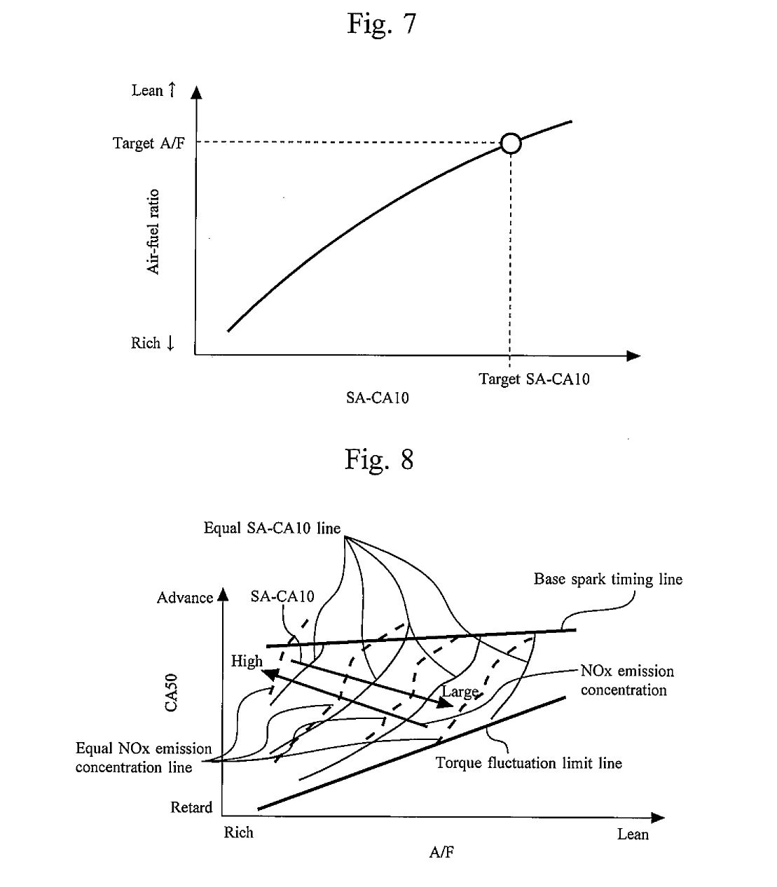

In step S112, the ECU 40 calculates a target SA-CA10. FIG. 7 is a graph that illustrates a relation between the air-fuel ratio and SA-CA10. This relation is obtained at a lean air-fuel ratio range on a side leaner than the stoichiometric air-fuel ratio and at the same operating condition (more specifically, an engine operating condition in which the engine load factor and the engine speed are equal). As shown in FIG. 7, a constant correlation is present between the actual SA-CA10 and the air-fuel ratio, and the actual SA-CA10 becomes greater as the air-fuel ratio is leaner. In addition, even if the air-fuel ratio is equal, the actual SA-CA10 varies in accordance with the engine operating condition (herein, engine load factor and engine speed). Accordingly, in the memory 40a of the ECU 40, a map (not shown in the drawings) that defines, taking into consideration the target air-fuel ratio at each engine operating condition, a relation between the engine operating condition (more specifically, engine load factor and engine speed) and the target SA-CA10 is stored.

More specifically, if the engine load factor increases, the actual SA-CA10 decreases since the ignitability improves due to increases of the in-cylinder pressure and the in-cylinder gas temperature at the time of combustion. Accordingly, the target SA-CA10 is set as a value that is greater as the engine load is higher. In addition, if the engine speed increases, the actual SA-CA10 increases since a change amount of the crank angle per unit time increases. Accordingly, the target SA-CA10 is set as a value that is smaller as the engine speed is higher. With this kind of setting, the target SA-CA10 can be set in such a manner that a desired ignition delay period (that is, the degree of stability of combustion) is obtained without depending on changes of the engine load factor and the engine speed. In this step S112, the target SA-CA10 is calculated in accordance with the current engine operating condition with reference to this kind of map.

An additional explanation on the processing of step S112 is made below. According to the processing of step S112, the target SA-CA10 is calculated as a value depending on the current engine operating condition (engine load factor and engine speed). In the present embodiment with this kind of processing, when the aforementioned engine operating condition is changed before and after the execution of the retard of the spark timing (that is, between the before-retard cycle and the retard execution cycle), the target SA-CA10 is corrected from a value at the before-retard cycle, by an amount according to the change amount of the engine operating condition. More specifically, the target SA-CA10 is corrected so as to be greater as an increase amount of the engine load factor is greater, and, conversely, the target SA-CA10 is corrected so as to be smaller as a decrease amount of the engine load factor is greater. In addition, the target SA-CA10 is corrected so as to be smaller as an increase amount of the engine speed is greater, and, conversely, the target SA-CA10 is corrected so as to be greater as a decrease amount of the engine speed is greater.

Next, the ECU 40 calculates an actual SA-CA10 (step S114). The actual SA-CA10 can be calculated by subtracting, from the actual CA10 at the current combustion cycle, the target spark timing that is used at the current combustion cycle. The actual CA10 can be calculated using the output values of the in-cylinder pressure sensor 30, as described with reference to FIG. 2. In particular, if the current combustion cycle is the retard execution cycle, the actual SA-CA10 at the retard execution cycle can be calculated with the processing of this step S114.

Next, the ECU 40 calculates a difference ΔSA-CA10 between the target SA-CA10 and the actual SA-CA10 that are calculated in steps S112 and S114, respectively, and further calculate a correction amount of the fuel injection amount so as to cause this difference ΔSA-CA10 to approach zero (step S116). More specifically, if the actual SA-CA10 is greater than the target SA-CA10, the correction amount described above is increased to decrease the actual SA-CA10 (in other words, to enrich the air-fuel ratio). If the processing of this step S116 is executed for the retard execution cycle, the correction amount described above corresponds to the above-described increment value F since the actual SA-CA10 is greater than the target SA-CA10. If, on the other hand, the actual SA-CA10 is smaller than the target SA-CA10, the correction amount described above is decreased to increase the actual SA-CA10 (in other words, to make lean the air-fuel ratio). If the processing of this step S116 is executed for a combustion cycle at which the advance of the spark timing is executed, the correction amount described above is decreased in this way since the actual SA-CA10 is smaller than the target SA-CA10. Note that the target fuel injection amount that is finally commanded to the fuel injection valve 26 is a value that is obtained by adding various correction amounts for fuel injection amount to the base fuel injection amount. The base fuel injection amount can be calculated with reference to a map (not shown in the drawings) that defines a relation between the engine operating condition (for example, engine load factor and engine speed) and the base fuel injection amount) while taking into consideration the target air-fuel ratio at each engine operating condition.

According to the routine shown in FIG. 6 described so far, if a spark timing command is issued during performance of the SA-CA10 feedback control, this feedback control is continuously performed. As a result, the increment value F can be determined in such a manner that the actual SA-CA10 at the retard execution cycle approaches the target SA-CA10, and the fuel increment can be performed, with a determined increment value F, in association with the retard of the spark timing. Therefore, the difference between the actual SA-CA10s at the combustion cycles before and after the execution of the retard of the spark timing can be decreased using the target SA-CA10 used in the feedback control described above. According to the method of the present embodiment, first, the spark timing is retarded in association with the enrichment of the air-fuel ratio. The method can thereby retard the spark timing while causing the torque fluctuation limit to be harder to be reached as compared with an example of executing only the retard of the spark timing. In addition, according to the method, an injected fuel can be incremented in such a manner that a change of the actual SA-CA10 as a result of execution of the retard of the spark timing is reduced, and an increase of the burning velocity due to an excessive fuel increment can thereby be reduced. Therefore, a knock can be prevented from being adversely induced due to a fuel increment being executed in association with the retard of the spark timing. As just described, by using the fuel increment value F, the value of the fuel increment that is executed in association with the retard of the spark timing can be properly determined.

Moreover, as already described with reference to FIG. 5, the equal SA-CA10 lines have a tendency in which SA-CA10 becomes smaller as CA50 is retarded to a greater extent. Thus, if the spark timing is retarded from the operating point p1 at the base spark timing, a change of the air-fuel ratio as a result of the retard with the predetermined amount R1 decreases at the initial stage of the retard, and the air-fuel ratio is enriched to a greater extent as a result of the retard with the predetermined amount R1 being repeatedly executed. Consequently, an increase of fuel consumption due to enrichment of the air-fuel ratio can be reduced at the initial stage of the retard in which the margin with respect to the torque fluctuation limit line is large. In addition, under conditions where the operating point p is near the torque fluctuation limit line, the retard of the spark timing can be executed with an increase of torque fluctuation being reduced by use of the fuel increment value F that is proper and greater than that at the initial stage of the retard.

Further, FIG. 8 is a graph for explaining an effect of utilizing SA-CA10 as a combustion index value for determining the fuel increment value F that is associated with the retard of the spark timing. In FIG. 8, a relation that is fixed using CA50 and the air-fuel ratio is used as with FIG. 5, and equal NOx emission concentration lines are illustrated in addition to the equal SA-CA10 lines. It can be said, as shown in FIG. 8, that the equal NOx emission concentration lines are relatively parallel to the equal SA-CA10 lines. Also, in the lean air-fuel ratio range, the NOx emission concentration on the equal NOx emission concentration line located on the left side in FIG. 8 (that is, the rich side) is greater than that on the equal NOx emission concentration line located on the right side. Because of this, it can be said that, in terms of NOx emission concentration, it is not favorable to determine the fuel increment value F in such a manner that the operating point p moves to the richer side than the equal SA-CA10 line. Based on the above, by executing the retard of the spark timing while keeping nearly uniform a combustion index value (such as SA-CA10 used in the present embodiment) having a relation in which an equal combustion index value line is relatively parallel to an equal NOx emission concentration line, the fuel increment can be associated with the retard of the spark timing with a good balance also in terms of maintaining the stability of combustion and of reducing an increase of exhaust emission.

Further, according to the routine shown in FIG. 6, even if the advance request for the spark timing is issued, the actual SA-CA10s at the combustion cycles before and after the execution of the retard of the spark timing can be kept nearly uniform using the target SA-CA10 used in the feedback control described above, as with the example where the retard request is issued.

Furthermore, according to the routine described above, the target SA-CA10 that is used at the retard execution cycle can be properly corrected in such a manner that the degree of stability of combustion do not change as a result of a change of the engine operating condition (that is, engine load factor and engine speed) before and after the execution of the retard of the spark timing.

In the routine shown in FIG. 6 according to the first embodiment described above, even if any of the retard request and the advance request for the spark timing is issued, the fuel injection amount is increased or decreased in such a manner that the actual SA-CA10 is kept nearly uniform at the combustion cycles before and after the execution of a change of the spark timing. However, in contrast to this kind of configuration, the processing of a routine may be configured so that, only when the retard request for the spark timing is issued, a fuel increment is executed in such a manner that the actual SA-CA10 is kept nearly uniform before and after the combustion cycles before and after the execution of the retard of the spark timing.

Note that, in the above described first embodiment, the target SA-CA10 calculated when the processing of step S112 is executed following the processing of step S106 corresponds to the “target combustion index value” according to the present disclosure. In addition, the ECU 40 that is programmed to: execute the processing of step S114; execute the processing of step S106; execute the processing of step S116 following step S106; and execute the SA-CA10 feedback control described above, corresponds to the “controller” according to the present disclosure.

In the first embodiment described above, SA-CA10 is taken as an example of the combustion index value that indicates the stability of combustion. However, as an alternative to SA-CA10, any desired crank angle period from the spark timing (SA) to an arbitrary specified fraction combustion point CAα other than CA10 can be, for example, used as the “combustion index value” according to the present disclosure, as far as it is a parameter that represents the stability of combustion (more specifically, the stability of main combustion). In addition, the velocity of main combustion or the variation value thereof may be, for example, used as the “combustion index value”, instead of the example described above. With a main combustion period (for example, CA10-90 or CA10-50) that is calculated using the measured data of MFB based on the output values of the in-cylinder pressure sensor 30, the velocity of main combustion can be calculated as a value that is higher as the main combustion period is shorter. The variation value of the velocity of main combustion can be calculated, for example, using a variation value of the main combustion period described above. Furthermore, if, for example, the main combustion period described above is used as the combustion index value, the actual main combustion period becomes longer than a target main combustion period when the retard of the spark timing for reducing knock is executed. By executing an fuel increment to cause the actual main combustion period to approach the target main combustion period when the actual main combustion period is longer than the target main combustion period, the actual main combustion period can be kept nearly uniform before and after the execution of the retard of the spark timing. This also applies to the variation value of the velocity of main combustion. That is, when the retard of the spark timing is executed, the actual variation value of the velocity of main combustion becomes greater than a target variation value thereof. Therefore, by executing a fuel increment to cause the actual variation value to approach the target variation value, the actual variation value of the velocity of main combustion can be kept nearly uniform before and after the execution of the retard of the spark timing.

Moreover, in the first embodiment, the example has been described in which, during the lean burn operation, the retard control of the spark timing is executed in association with the fuel increment with the increment value F. However, the present control may be, for example, applied to a stoichiometric air-fuel ratio burn operation, instead of the lean burn operation. More specifically, if, for example, a large amount of EGR gas is introduced, a torque fluctuation is easy to be greater even during the stoichiometric air-fuel ratio burn operation in which the stability of combustion is basically higher than during the lean burn operation. Accordingly, the present control can be favorably applied to the stoichiometric air-fuel ratio burn operation.

Moreover, in the first embodiment, the example has been described in which the target SA-CA10 is corrected based on both of change amounts of the engine load factor and the engine speed when the engine load factor and the engine speed are changed before and after the execution of the retard of the spark timing. However, this kind of correction may not be necessarily performed, or the target SA-CA10 may be corrected on the basis of any one of the change amounts of the engine load factor and the engine speed. In addition, other than the engine load factor and the engine speed, if at least one of the intake air temperature and the engine cooling water temperature varies before and after the execution of the retard of the spark timing, the SA-CA10 may be corrected on the basis of at least one of the intake air temperature and the engine cooling water temperature.

In the first embodiment, the retard control of the spark timing that is executed when the retard request is issued for reducing knock (that is, retard control executed as a part of the knock control) has been described. The knock level may be defined on the basis of any one of the knock intensity and the knock frequency, instead of being defined on the basis of both of the knock intensity and the knock frequency as described above. Therefore, the retard request for reducing knock also includes a request that is issued in a simple configuration in which it is determined, for example, that a knock has occurred when the knock intensity is equal to or greater than a determination threshold value and the retard of the spark timing is executed when it is determined that a knock has occurred.

Further, in the first embodiment, the example has been described in which detection of knock is performed using the knock sensor 46 of a type detecting the vibration of the cylinder block. However, the “controller” according to the present disclosure may be configured to detect knock, for example, using the in-cylinder pressure sensor 30, instead of the knock sensor 46 of the aforementioned type. More specifically, a peak value of the intensity of the output signals (that is, signals for knock determination) of the in-cylinder pressure sensor 30 in a predetermined crank angle period for knock detection may be calculated as the knock intensity, or an integral value of the intensity of the signals for knock determination may also be calculated as the knock intensity.

Furthermore, in the first embodiment, taking, as an example, the internal combustion engine 10 that includes the in-cylinder pressure sensor 30 in each cylinder, the increment control of injected fuel at the time of the retard of the spark timing, which uses SA-CA10 based on the output values of the in-cylinder pressure sensor 30 in each cylinder, has been described. However, this increment control of injected fuel can be executed, as far as at least one cylinder includes the in-cylinder pressure sensor 30. Therefore, for example, a specified one cylinder that is a representative cylinder may include the in-cylinder pressure sensor 30, and a combustion index value, such as SA-CA10 based on the output values of this in-cylinder pressure sensor 30, may be calculated. Further, a fuel increment value for another cylinder including the representative cylinder may be controlled using a calculated combustion index value.

What is claimed is:

1. A control apparatus for an internal combustion engine, the internal combustion engine including:
an ignition device configured to ignite air-fuel mixture in a cylinder;
a fuel injection valve configured to supply fuel in the cylinder; and
an in-cylinder pressure sensor configured to detect an in-cylinder pressure,
the control apparatus comprising a controller, the controller being programmed to:
(a) detect a knock;
(b) calculate, based on an output value of the in-cylinder pressure sensor, an actual combustion index value of a combustion index value that indicates a stability of combustion;
(c) control a fuel injection amount in such a manner that the actual combustion index value approaches a target combustion index value that is based on an engine operating condition;
(d) retard a spark timing in reducing knock based on a knock detection result; and
(e) execute a fuel increment in such a manner that the actual combustion index value at a retard execution cycle that is a combustion cycle at which a retard of the spark timing for reducing knock is executed approaches the target combustion index value of a before-retard cycle that is one or a plurality combustion cycles immediately before the retard execution cycle.

2. The control apparatus according to claim 1,
wherein the target combustion index value is corrected based on a change amount of a value of engine load factor at the retard execution cycle with respect to a value of the engine load factor at the before-retard cycle.

3. The control apparatus according to claim 1,
wherein the target combustion index value is corrected based on a change amount of a value of an engine speed at the retard execution cycle with respect to a value of the engine speed at the before-retard cycle.
